(19) United States
(12) Patent Application Publication
(10) Pub. No.: US 2025/0070263 A1
(43) Pub. Date: Feb. 27, 2025

(54) SECONDARY BATTERY

(71) Applicant: SAMSUNG SDI CO., LTD., Yongin-si (KR)

(72) Inventors: Jae Hyung KIM, Yongin-si (KR); Hyung Dong LEE, Yongin-si (KR)

(21) Appl. No.: 18/606,247

(22) Filed: Mar. 15, 2024

(30) Foreign Application Priority Data
Aug. 22, 2023 (KR) 10-2023-0109712

(51) Int. Cl. H01M 10/0587; H01M 4/525; H01M 10/0525; H01M 50/178

(52) U.S. Cl. CPC H01M 10/0587; H01M 4/525; H01M 10/0525; H01M 50/178

(57) ABSTRACT

A secondary battery includes an electrode assembly in which a negative electrode plate, a separator, and a positive electrode plate are laminated and wound; and an exterior material accommodating the electrode assembly, wherein the positive electrode plate includes a conductive base material layer having first and second surfaces, the second surface being an opposite surface of the first surface, a first functional layer on the first surface of the conductive base material layer, a first electrically active material layer on the first functional layer, a first insulating layer on the first surface of the conductive base material layer, the first insulating layer being spaced apart from the first functional layer and the first electrically active material layer, and a first lamination tape covering a part of the first functional layer, the first electrically active material layer, the first insulating layer, and the first surface of the conductive base material layer.

### CROSS-REFERENCE TO RELATED APPLICATION

The present application claims priority to and the benefit of Korean Patent Application No. 10-2023-0109712, filed on Aug. 22, 2023, in the Korean Intellectual Property Office, the entire disclosure of which is incorporated herein by reference.

### BACKGROUND

### 1. Field

Embodiments relate to a secondary battery.

### 2. Description of the Related Art

A secondary battery is a battery, which may be charged and discharged, unlike a primary battery, which cannot be charged. A low-capacity secondary battery may be used in small portable electronic devices such as smartphones, feature phones, tablet computers, laptop computers, digital cameras, and camcorders, and a large-capacity secondary battery may be used as a motor driving power source, a power storage battery, and the like in hybrid vehicles, electric vehicles, or the like.

Such secondary batteries may include an electrode assembly including a negative electrode, a separator, and a positive electrode, a case which accommodates the same, and an electrode terminal connected to the electrode assembly. Secondary batteries may be classified into circular types, prismatic types, pouch types, or the like according to their shape.

### SUMMARY

The embodiments may be realized by providing a secondary battery including an electrode assembly in which a negative electrode plate, a separator, and a positive electrode plate are laminated and wound; and an exterior material accommodating the electrode assembly, wherein the positive electrode plate includes a conductive base material layer having a first surface and a second surface, the second surface being an opposite surface of the first surface, a first functional layer on the first surface of the conductive base material layer, a first electrically active material layer on the first functional layer, a first insulating layer on the first surface of the conductive base material layer, the first insulating layer being spaced apart from the first functional layer and the first electrically active material layer, and a first lamination tape covering a part of the first functional layer, the first electrically active material layer, the first insulating layer, and the first surface of the conductive base material layer.

An end of the first functional layer may extend beyond an end of the first electrically active material layer.

An end of the first functional layer may be aligned with an end of the first electrically active material layer.

The first lamination tape may be in contact with the first functional layer.

A width of the first lamination tape may be larger than a width of the positive electrode plate.

The positive electrode plate may further include a second insulating layer on the second surface of the conductive base material layer.

The positive electrode plate may further include a second lamination tape attached to a region of the second insulating layer underlying the first lamination tape.

An area of the second lamination tape may be the same as an area of the first lamination tape.

A region of the first functional layer exposed by the first electrically active material layer may be sealed by the first lamination tape and the second lamination tape.

The positive electrode plate may further include a second functional layer on the second surface of the conductive base material layer in a region spaced apart from the second insulating layer; a second electrically active material layer on the second functional layer; and a third lamination tape covering a part of the second functional layer, the second electrically active material layer, the second insulating layer, and the second surface of the conductive base material layer.

A end of the second functional layer may extend beyond an end of the second electrically active material layer.

An end of the second functional layer may be aligned with an end of the second electrically active material layer.

The first lamination tape, the second lamination tape, and the third lamination tape may each independently include polyethylene terephthalate or polyimide.

The first functional layer and the second functional layer may each independently include a lithium iron phosphate, the first electrically active material layer and the second electrically active material layer may each independently include a nickel cobalt oxide, a nickel cobalt manganese, or a nickel cobalt aluminum, and the first insulating layer and the second insulating layer may each independently include a ceramic.

The electrode assembly may further include a positive electrode tab connected to the positive electrode plate and extending outside of the exterior material, and a negative electrode tab connected to the negative electrode plate and extending outside of the exterior material.

### BRIEF DESCRIPTION OF THE DRAWINGS

Features will be apparent to those of skill in the art by describing in detail exemplary embodiments with reference to the attached drawings in which:

FIG. 1 is an exploded perspective view illustrating an exemplary secondary battery according to the present disclosure;

FIG. 2 is a cross-sectional view illustrating an exemplary electrode assembly according to the present disclosure;

FIGS. 3A and 3B are views illustrating a first surface (inner surface) and a second surface (outer surface) of an exemplary electrode plate according to the present disclosure; and

FIGS. 4A and 4B are cross-sectional views of the exemplary electrode plate according to the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used in the present specification, the terms “or” and “and/or” are not intended to be exclusive terms, and include any one of and all combinations of one or more of the listed items. Further, the meaning of being “connected” in the present specification refers to not only a case in which member A and member B are directly connected, but also a case in which member C is interposed between member A and member B to indirectly connect member A and member B.

As used in the present specification, a singular form may include a plural form unless the context clearly indicates otherwise. Further, when used in the present specification, “include,” “including,” “comprise,” and/or “comprising” specify(ies) the presence of mentioned features, numbers, steps, operations, members, elements and/or groups thereof, and do(es) not exclude the presence or addition of one or more other features, numbers, steps, operations, members, elements and/or groups.

Although the terms first, second, and the like may be used in the present specification to describe various members, components, regions, layers and/or parts, it is clear that these members, components, regions, layers and/or parts should not be limited by these terms. These terms are used only to distinguish one member, component, region, layer, or part from another member, component, region, layer, or part, and are not intended to imply or require sequential inclusion. Accordingly, a first member, component, region, layer, or part to be described later may refer to a second member, component, region, layer, or part without departing from teachings of the present disclosure.

Spatially-related terms such as “beneath,” “below,” “lower,” “above,” and “upper” are used for easy understanding of one element or feature and another element or feature shown in the drawings. These spatially-related terms are provided for easy understanding of the present disclosure according to various process states or usage states of the present disclosure, and are not intended to limit the present disclosure. For example, when the elements or features in the drawings are reversed, an element described as “lower” or “below” “becomes “upper” or “above.” Accordingly, “below” is a concept encompassing “above” or “below.”

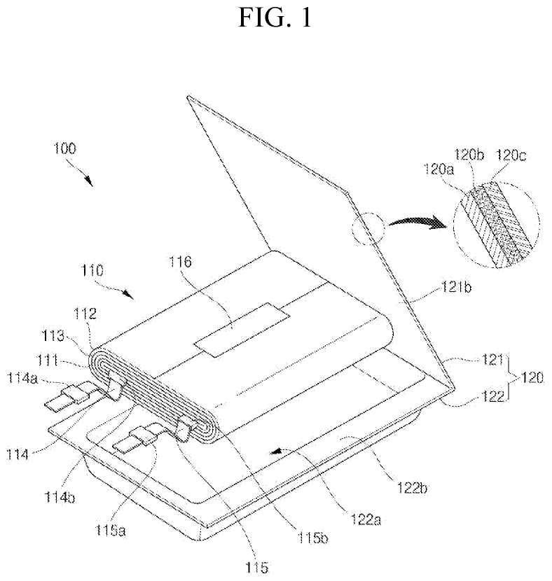

In FIG. 1, an exploded perspective view of an exemplary secondary battery 100 according to the present disclosure is shown. As shown in FIG. 1, the secondary battery 100 according to the present disclosure may include an electrode assembly 110 and an exterior material 120.

The electrode assembly 110 may include a negative electrode plate 111, a positive electrode plate 112, and a separator 113 between the negative electrode plate 111 and the positive electrode plate 112. In an implementation, the electrode assembly 110 may be configured or formed by laminating the separator 113, the negative electrode plate 111, the separator 113, and the positive electrode plate 112 and winding the separator 113, the negative electrode plate 111, the separator 113, and the positive electrode plate 112 in a jelly roll form.

In an implementation, a negative electrode tab 114 may be electrically coupled to the negative electrode plate 111 and extend to the outside of the exterior material 120. In an implementation, a positive electrode tab 115 may be electrically coupled to the positive electrode plate 112 and extend to the outside of the exterior material 120.

In an implementation, a partial region of the negative electrode tab 114 may be wrapped by an insulating member 114a, the insulating member 114a may be in contact with a sealing region of the exterior material 120, and the negative electrode tab 114 may not be electrically short-circuited with the exterior material 120. In an implementation, a partial region of the negative electrode plate 111 and a partial region of the negative electrode tab 114 may be wrapped together by an insulating member 114b, and the negative electrode plate 111 and the negative electrode tab 114 may not be electrically short-circuited with the positive electrode plate 112 of an opposite polarity.

In an implementation, a partial region of the positive electrode tab 115 may be wrapped by an insulating member 115a, the insulating member 115a may be in contact with the sealing region of the exterior material 120, and the positive electrode tab 115 may not be electrically short-circuited with the exterior material 120. In an implementation, a partial region of the positive electrode plate 112 and a partial region of the positive electrode tab 115 may be wrapped together by an insulating member 115b, and the positive electrode plate 112 and the positive electrode tab 115 may not be electrically short-circuited with the negative electrode plate 111 of an opposite polarity.

In an implementation, a finishing tape 116 may be adhered to an outermost partial region (e.g., a winding finish region) of the electrode assembly 110 wound in a jelly roll form, and a wound shape of the electrode assembly 110 may be maintained without being unwound.

The exterior material 120 may accommodate the electrode assembly 110 and seal an outer circumference of the electrode assembly 110. The exterior material 120 may include or be referred to as a case, can, or pouch.

In an implementation, the pouch exterior material 120 may include a first exterior portion 121 and a second exterior portion 122 of which one end is connected to the first exterior portion 121. The first exterior portion 121 may be in contact with one side of the electrode assembly 110, and the second exterior portion 122 may include a recess 122a that accommodates the other side of the electrode assembly 110. In an implementation, the first exterior portion 121 may also include a recess that accommodates a partial region of the electrode assembly 110.

In an implementation, circumferences or peripheral regions of the first and second exterior portions 121 and 122 corresponding to the outer circumference of the electrode assembly 110 may be thermally fused with each other, and the electrode assembly 110 may be accommodated in the exterior material 120, which is an approximately pouch or pocket type. In an implementation, the pouch exterior material 120 may be formed by bending an integrally formed quadrangular plate-shaped exterior plate in approximately the middle based on a longitudinal direction of one side to form the first exterior portion 121 and the second exterior portion 122. In an implementation, the second exterior portion 122 may be provided with the recess (or cavity) 122a of a certain depth in which the electrode assembly 110 may be accommodated through press or drawing processing or the like, and sealing portions 121b and 122b may be at an outer circumference of the recess 122a for sealing the first and second exterior portions 121 and 122 to each other. The sealing portions 121b and 122b may be molded along one side where the first and second exterior portions 121 and 122 are in integral contact with each other and the remaining three sides.

In an implementation, the pouch exterior material 120 may include a multilayer or laminate structure having a first insulating layer 120a, a metal layer 120b, and a second insulating layer 120c. In an implementation, an adhesive layer or a functional layer may be added.

The first insulating layer 120a may be an inner side surface of the pouch exterior material 120 and may include a material having an insulating property and a thermally adhesive property. In an implementation, the first insulating layer 120a may be on one surface of the metal layer 120b and may configure an inner side surface of the pouch exterior material 120 facing the electrode assembly 110. In an implementation, the first insulating layer 120a may include, e.g., a non-stretchable polypropylene film (cast polypropylene film) that does not react with an electrolyte or the like. In an implementation, the electrode assembly 110 may be accommodated in the first and second exterior portions 121 and 122 and the first and second exterior portions 121 and 122 are folded to each other, and the first insulating layers 120a of the first and second exterior portions 121 and 122 may be in contact with each other. In an implementation, the sealing portions 121b and 122b may be thermally fused, the first insulating layers 120a of the first and second exterior portions 121 and 122 may be in contact with each other, and thus the pouch exterior material 120 may be sealed.

The metal layer 120b may be between the first insulating layer 120a and the second insulating layer 120c, may help prevent moisture and oxygen from entering from the outside, and may help prevent the electrolyte filled in the pouch exterior material 120 from leaking to the outside. In an implementation, the metal layer 120b may help maintain the mechanical strength of the pouch exterior material 120. In an implementation, the metal layer 120b may include, e.g., aluminum, an aluminum alloy, iron, or an iron alloy.

The second insulating layer 120c may be an outer side surface of the pouch exterior material 120, and may help alleviate mechanical and chemical impacts from external electronic devices. In an implementation, the second insulating layer 120c may be on the other side of the metal layer 120b and may configure an outer side surface of the pouch exterior material 120. In an implementation, the second insulating layer 120c may include, e.g., nylon, polyethylene terephthalate (PET), polybutylene terephthalate (PBT), or polybutylene naphthalate (PBN).

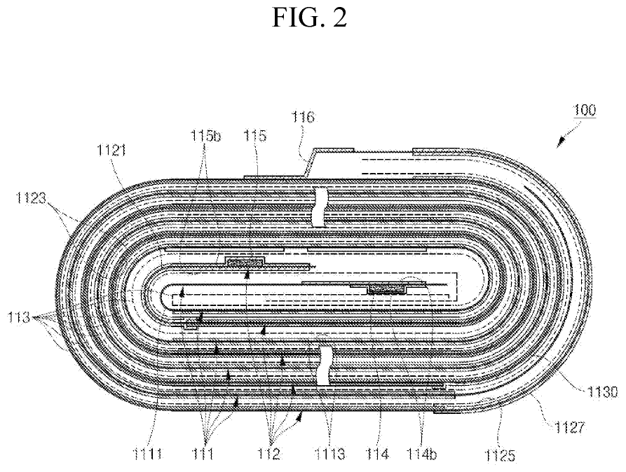

Referring to FIG. 2, a cross-sectional view of the exemplary electrode assembly 110 according to the present disclosure is shown. In FIG. 2, the electrode assembly 110 is shown in a loosely unwound state for understanding of the present disclosure. As shown in FIG. 2, the electrode assembly 110 may be configured by winding the separator 113, the negative electrode plate 111, the separator 113, and the positive electrode plate 112 in a jelly roll form in a state in which the separator 113, the negative electrode plate 111, the separator 113, and the positive electrode plate 112 are laminated. In an implementation, a region of the electrode assembly 110 where winding starts (e.g., a center region of the electrode assembly) may be defined or referred to as a winding front end, and a region where the winding ends (e.g., the outermost region of the electrode assembly) may be defined or referred to as a winding finish end.

In an implementation, the negative electrode tab 114 may be connected to a winding front end region of the negative electrode plate 111, and the negative electrode tab 114 and a partial region of the negative electrode plate 111 around the negative electrode tab 114 may be wrapped by the insulating member 114b. In an implementation, the positive electrode tab 115 may be connected to a winding front end region of the positive electrode plate 112, and the positive electrode tab 115 and a partial region of the positive electrode plate 112 around the positive electrode tab 115 may be wrapped by the insulating member 115b. In an implementation, the negative electrode tab 114 and the positive electrode tab 115 may be at an approximate center region of the electrode assembly 110. In an implementation, a partial region of the positive electrode plate 112, which is wound at least once, may be at approximately the outermost region of the electrode assembly 110. In an implementation, the finishing tape 116 may be attached to the winding finish end of the positive electrode plate 112.

In an implementation, the negative electrode plate 111 may include a conductive base material layer 1111 formed of, e.g., a copper or nickel foil or mesh, and negative electrode electrically active material layers 1113 (e.g., coated) on both surfaces of the conductive base material layer 1111. In an implementation, the conductive base material layer 1111 may include or be referred to as a negative electrode current collector plate. In an implementation, the negative electrode electrically active material layer 1113 may include, e.g., a carbon material, Si, Sn, tin oxide, a tin alloy composite, a transition metal oxide, lithium metal nitrite, or a metal oxide. In an implementation, a region of the negative electrode current collector plate 1111 not coated with the negative electrode electrically active material layer 1113 may be defined or referred to as a negative electrode uncoated portion. In an implementation, the above-described approximately flat negative electrode tab 114 may be coupled (e.g., welded) to the negative electrode uncoated portion of the negative electrode current collector plate 1111. In an implementation, one end of the negative electrode tab 114 may be electrically connected to the negative electrode uncoated portion, and the other end may protrude and extend to the outside. In an implementation, the negative electrode uncoated portion may be at a winding front end, a winding finish end, or an arbitrary region of the negative electrode plate 111.

In an implementation, the positive electrode plate 112 may include a conductive base material layer 1121 formed of, e.g., an aluminum foil or mesh, and a positive electrode electrically active material layer 1123 (e.g., coated) on both surfaces of the conductive base material layer 1121. In an implementation, the conductive base material layer 1121 may include or be referred to as a positive electrode current collector plate. In an implementation, the positive electrode electrically active material layer 1123 may include a chalcogenide compound, e.g., a nickel cobalt oxide (LCO), a nickel cobalt manganese (NCM), or a nickel cobalt aluminum (NCA). In an implementation, a region of the positive electrode current collector plate 1121 not coated with the positive electrode active material layer 1123 may be defined or referred to as a positive electrode uncoated portion. In an implementation, the above-described approximately flat positive electrode tab 115 may be coupled (e.g., welded) to the positive electrode uncoated portion of the positive electrode current collector plate 1121. In an implementation, one end of the positive electrode tab 115 may be electrically connected to the positive electrode uncoated portion, and the other end may protrude and extend to the outside. In an implementation, the positive electrode uncoated portion may be at a winding front end, a winding finish end, or an arbitrary region of the positive electrode plate 112.

In an implementation, the positive electrode plate 112 may include a first lamination tape 1125 and a second lamination tape 1127 attached to, e.g., the positive electrode uncoated portion of the winding finish end. In an implementation, the positive electrode plate 112 may include a third lamination tape 1130 attached to the positive electrode uncoated portion, e.g., in a region before the winding finish end. In an implementation, the first, second, and third lamination tapes 1125, 1127, and 1130 may overlap each other in a horizontal width direction in the electrode assembly 110.

In an implementation, the positive electrode plate 112 may further include a functional layer between the conductive base material layer 1121 and the positive electrode electrically active material layer 1123, and an insulating layer on the positive electrode uncoated portion where the positive electrode active material layer 1123 is not coated.

The separator 113 may be between the negative electrode plate 111 and the positive electrode plate 112 to help prevent an electrical short circuit between the negative electrode plate 111 and the positive electrode plate 112. In an implementation, a pair of separators 113 may be provided, and the negative electrode plate 111 may be held between the pair of separators 113. In an implementation, the separator 113 may include polyethylene, polypropylene, or a porous copolymer of the polyethylene and the polypropylene. In order to help prevent an electrical short circuit between the negative electrode plate 111 and the positive electrode plate 112, a width of the separator 113 may be wider than widths of the negative electrode plate 111 and the positive electrode plate 112.

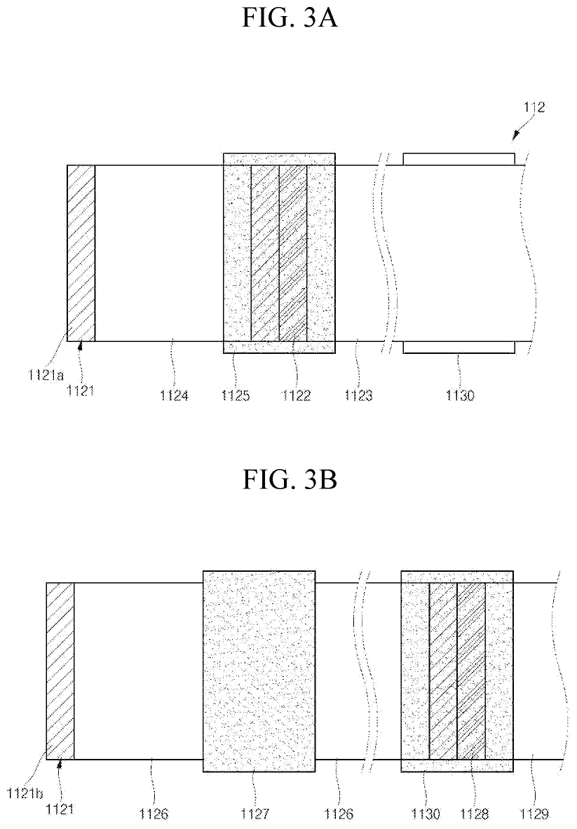

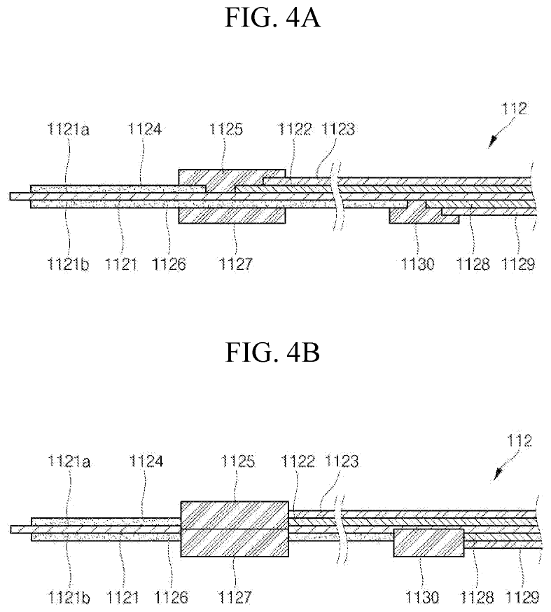

Referring to FIGS. 3A and 3B, a first surface 1121a (e.g., an inner surface) and a second surface 1121b (e.g., an outer surface) of an exemplary electrode plate (e.g., the positive electrode plate 112) according to the present disclosure are shown, and referring to FIGS. 4A and 4B, cross-sectional views of an exemplary electrode plate (e.g., the positive electrode plate 112) according to the present disclosure are shown. The electrode plate 112 shown here may represent a winding finish end region of the electrode assembly 110.

As shown in FIGS. 3A, 3B, 4A, and 4B, the positive electrode plate 112 may include the conductive base material layer 1121, a first functional layer 1122, the first electrically active material layer 1123, a first insulating layer 1124, and the first lamination tape 1125.

The conductive base material layer 1121 may include the first surface 1121a and the second surface 1121b, which is an opposite surface of the first surface 1121a. The first functional layer 1122 may be on the first surface 1121a of the conductive base material layer 1121. The first electrically active material layer 1123 may be on the first functional layer 1122. The first insulating layer 1124 may be on the first surface 1121a (e.g., a positive electrode uncoated portion) of the conductive base material layer 1121 spaced apart from the first functional layer 1122 and the first electrically active material layer 1123. The first lamination tape 1125 may directly cover (e.g., a part of) the first functional layer 1122, the first electrically active material layer 1123, the first insulating layer 1124, and the first surface 1121a of the conductive base material layer 1121 (e.g., a portion of the positive electrode uncoated portion that is between the first functional layer 1122 and the first insulating layer 1124).

In an implementation, an end of the first functional layer 1122 may extend from (e.g., may extend farther than) an end of the first electrically active material layer 1123. In an implementation, an end region of the first functional layer 1122 may be exposed from or beyond an end of the first electrically active material layer 1123. In an implementation, a distance from the end of the first functional layer 1122 to the first insulating layer 1124 may be less than a distance from the end of the first electrically active material layer 1123 to the first insulating layer 1124 (e.g., as measured in a same direction). In an implementation, an end position of the first functional layer 1122 may be the same as, e.g., may be aligned with, an end position of the first electrically active material layer 1123.

In an implementation, the first lamination tape 1125 may be in direct contact with the first functional layer 1122. In an implementation, a width of the first lamination tape 1125 may be larger than a width of the positive electrode plate 112. In an implementation, the first functional layer 1122 may be isolated from the electrolyte by or due to the first lamination tape 1125. In an implementation, the first functional layer 1122 may not react with the electrolyte and thus may not generate side reaction by-products. In an implementation, the first lamination tape 1125 may be in direct contact with each of the first electrically active material layer 1123, the first insulating layer 1124, and the first surface 1121a of the conductive base material layer 1121 in addition to the first functional layer 1122. In an implementation, the first lamination tape 1125 may cover a partial region of the first insulating layer 1124 adjacent to the first functional layer 1122, and the first insulating layer 1124 may not be contaminated with the side reaction by-products due to the first functional layer 1122 and the electrolyte.

In an implementation, the positive electrode plate 112 may further include a second insulating layer 1126 on the second surface 1121b of the conductive base material layer 1121. In an implementation, the positive electrode plate 112 may further include the second lamination tape 1127 attached to a region of the second insulating layer 1126 corresponding to, underlying, or aligned with the first lamination tape 1125. In an implementation, an area (e.g., a size and a shape) of the second lamination tape 1127 may be the same as an area of the first lamination tape 1125.

In an implementation, all regions of the first functional layer 1122 exposed through or by the first electrically active material layer 1123 may be sealed by the first and second lamination tapes 1125 and 1127. In an implementation, the regions (e.g. an upper surface and side surfaces) of the first functional layer 1122 exposed through the first electrically active material layer 1123 may be completely sealed by the first and second lamination tapes 1125 and 1127, and the first functional layer 1122 may not come into contact with the electrolyte. In an implementation, the first functional layer 1122 may not come into contact with the electrolyte, and elution of the first functional layer 1122 due to contact with the electrolyte does not occur. In an implementation, the first functional layer 1122 may not react with the electrolyte and generate side reaction by-products. In an implementation, an elution phenomenon of the first functional layer 1122 may be suppressed, such that the electrolyte is not unnecessarily consumed, a contamination phenomenon of the first insulating layer 1124 due to the side reaction by-products may not occur, and battery life may ultimately increase.

In an implementation, the positive electrode plate 112 may further include a second functional layer 1128 (e.g., coated) on the second surface 1121b of the conductive base material layer 1121 in a region spaced apart from the second insulating layer 1126 and may also further include a second electrically active material layer 1129 on the second functional layer 1128. In an implementation, the positive electrode plate 112 may include the third lamination tape 1130, which may (e.g., at least partially) cover the regions of the second functional layer 1128, the second electrically active material layer 1129, the second insulating layer 1126, and the second surface 1121b of the conductive base material layer 1121.

In an implementation, an end of the second functional layer 1128 may extend from or beyond an end of the second electrically active material layer 1129. In an implementation, an end position of the second functional layer 1128 may be the same as an end position of the second electrically active material layer 1129.

In an implementation, only a winding finish end region of the first functional layer 1122 at a winding finish region may be exposed from or beyond the first electrically active material layer 1123, and all of the remaining regions may be covered by the first electrically active material layer 1123. In an implementation, the winding finish end region of the first functional layer 1122 exposed through or by the first electrically active material layer 1123 may be sealed by the first and second lamination tapes 1125 and 1127. In an implementation, only a winding finish end region of the second functional layer 1128 may be exposed from or by the second electrically active material layer 1129, and all of the remaining regions may be covered by the second electrically active material layer 1129. In an implementation, the winding finish end region of the second functional layer 1128 exposed through or by the second electrically active material layer 1129 may be sealed by the third lamination tape 1130.

In an implementation, at least one of the first, second, and third lamination tapes 1125, 1127, and 1130 may include, e.g., polyethylene terephthalate (PET) or polyimide (PI), which may not react with the electrolyte.

In an implementation, at least one of the first and second functional layers 1122 and 1128 may include, e.g., lithium iron phosphate (LFP). This LFP layer may be between the conductive base material layer 1121 and the first and second electrically active material layers 1123 and 1129 to help reduce electrical resistance and help suppress a heat generation phenomenon. In an implementation, at least one of the first and second electrically active material layers 1123 and 1129 may include, e.g., nickel cobalt oxide (LCO), nickel cobalt manganese (NCM), or nickel cobalt aluminum (NCA). Such electrically active materials may allow the secondary battery 100 to be charged and discharged as lithium ions are intercalated or deintercalated. In an implementation, at least one of the first and second insulating layers 1124 and 1126 may include a ceramic. This ceramic may help improve battery safety by preventing the positive electrode conductive base material layer 1121 from being directly electrically short-circuited with the negative electrode conductive base material layer 1111.

In an implementation, the functional layer including LFP may be isolated from the electrolyte by the lamination tape, and elution of the LFP from the functional layer when the secondary battery is charged or discharged or the secondary battery is left in a high temperature and high humidity environment may be prevented. If the functional layer were to meet the electrolyte and be eluted, a total amount of electrolyte, which moves lithium ions, could decrease and ceramic characteristics could also deteriorate, battery life could ultimately decrease.

The secondary battery according to an embodiment may have an extended lifespan. The secondary battery according to an embodiment may have an extended lifespan by preventing a functional layer of an electrode assembly from being exposed to and/or reacting with an electrolyte. The secondary battery according to an embodiment may have an extended lifespan by preventing a functional layer of an electrode assembly from eluting into an electrolyte. The secondary battery according to an embodiment may have an extended lifespan by preventing by-products of side reactions between a functional layer and an electrolyte from reaching an insulating layer of an electrode assembly.

One or more embodiments may provide a secondary battery having an extended lifespan.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. A secondary battery, comprising:
an electrode assembly in which a negative electrode plate, a separator, and a positive electrode plate are laminated and wound; and
an exterior material accommodating the electrode assembly,
wherein the positive electrode plate includes:
a conductive base material layer having a first surface and a second surface, the second surface being an opposite surface of the first surface,
a first functional layer on the first surface of the conductive base material layer,
a first electrically active material layer on the first functional layer,
a first insulating layer on the first surface of the conductive base material layer, the first insulating layer being spaced apart from the first functional layer and the first electrically active material layer, and
a first lamination tape covering a part of the first functional layer, the first electrically active material layer, the first insulating layer, and the first surface of the conductive base material layer.

2. The secondary battery of claim 1, wherein an end of the first functional layer extends beyond an end of the first electrically active material layer.

3. The secondary battery of claim 1, wherein an end of the first functional layer is aligned with an end of the first electrically active material layer.

4. The secondary battery of claim 1, wherein the first lamination tape is in contact with the first functional layer.

5. The secondary battery of claim 1, wherein a width of the first lamination tape is larger than a width of the positive electrode plate.

6. The secondary battery of claim 1, wherein the positive electrode plate further includes a second insulating layer on the second surface of the conductive base material layer.

7. The secondary battery of claim 6, wherein the positive electrode plate further includes a second lamination tape attached to a region of the second insulating layer underlying the first lamination tape.

8. The secondary battery of claim 7, wherein an area of the second lamination tape is the same as an area of the first lamination tape.

9. The secondary battery of claim 7, wherein a region of the first functional layer exposed by the first electrically active material layer is sealed by the first lamination tape and the second lamination tape.

10. The secondary battery of claim 7, wherein the positive electrode plate further includes:
a second functional layer on the second surface of the conductive base material layer in a region spaced apart from the second insulating layer;
a second electrically active material layer on the second functional layer; and
a third lamination tape covering a part of the second functional layer, the second electrically active material layer, the second insulating layer, and the second surface of the conductive base material layer.

11. The secondary battery of claim 10, wherein an end of the second functional layer extends beyond an end of the second electrically active material layer.

12. The secondary battery of claim 10, wherein an end of the second functional layer is aligned with an end of the second electrically active material layer.

13. The secondary battery of claim 10, wherein the first lamination tape, the second lamination tape, and the third lamination tape each independently include polyethylene terephthalate or polyimide.

14. The secondary battery of claim 10, wherein:
the first functional layer and the second functional layer each independently include a lithium iron phosphate,
the first electrically active material layer and the second electrically active material layer each independently include a nickel cobalt oxide, a nickel cobalt manganese, or a nickel cobalt aluminum, and
the first insulating layer and the second insulating layer each independently include a ceramic.

15. The secondary battery of claim 1, wherein the electrode assembly further includes:
a positive electrode tab connected to the positive electrode plate and extending outside of the exterior material, and
a negative electrode tab connected to the negative electrode plate and extending outside of the exterior material.
